(19) United States
(12) Patent Application Publication
(10) Pub. No.: US 2003/0100449 A1
(43) Pub. Date: May 29, 2003

(54) Solid herbicidal composition

(76) Inventors: Masaru Maeda, Kusatsu-shi (JP); Manabu Shimizu, Kusatsu-shi (JP)

Correspondence Address: SUGHRUE MION, PLLC, 2100 PENNSYLVANIA AVENUE, N.W., WASHINGTON, DC, 20037, US

(21) Appl. No.: 10/258,449

(22) PCT Filed: Apr. 25, 2001
(86) PCT No.: PCT/JP01/03578

(30) Foreign Application Priority Data
Apr. 26, 2000 (JP) 2000-125475

(51) Int. Cl. A01N 57/00; A01N 43/60

(52) U.S. Cl. 504/127; 504/136

(57) ABSTRACT

A solid herbicidal composition, comprising (1) 1-(4,6-dimethoxypyrimidin-2-yl)-3-(3-trifluoromethyl-2-pyridylsulfonyl)urea or a salt thereof, (2) at least one member selected from the group consisting of N-(phosphonomethyl)glycine, 4-[hydroxy(methyl)phosphinoyl]-homoalanine, 4-[hydroxy(methyl)phosphinoyl]-homoalanylalanylalanine and salts thereof, (3) a surfactant, and (4) a stabilizer.

### TECHNICAL FIELD

The present invention relates to a solid herbicidal composition, comprising (1) 1-(4,6-dimethoxypyrimidin-2-yl)-3-(3-trifluoromethyl-2-pyridylsulfonyl)urea (common name: flazasulfuron) or a salt thereof, (2) at least one member selected from the group consisting of N-(phosphonomethyl)glycine (common name: glyphosate), 4-[hydroxy(methyl)phosphinoyl]homoalanine (common name: glufosinate), 4-[hydroxy(methyl)phosphinoyl]-homoalanylalanylalanine (common name: bilanafos) and salts thereof, (3) a surfactant, and (4) a stabilizer. Also, the present invention relates to a method for inhibiting growth of an undesirable plant using the solid herbicidal composition.

### BACKGROUND ART

JP-A-5-271021 discloses an improved herbicidal composition, comprising, as active ingredients, flazasulfuron or a salt thereof and at least one member selected from the group consisting of glyphosate, glufosinate, bilanafos and salts thereof, to which an inorganic magnesium salt is added. In the herbicidal composition, the inorganic magnesium salt is added so that the active ingredients in a spray liquid is stabilized, the acidity of the spray liquid is improved, and the hygroscopicity of the formulation is inhibited when the improved herbicidal composition is diluted with water and sprayed. JP-A-5-9101 discloses an agricultural composition, comprising a) an agricultural active ingredient, b) a surfactant, c) a carbonate, d) a solid acid and e) boric anhydride and/or metaboric acid. In the agricultural composition, boric anhydride and/or metaboric acid is added so that generation of carbon dioxide accompanied with the reaction between the carbonate and the solid acid during storage of the agricultural composition is inhibited. Thus, the background arts neither disclose nor suggest the present invention, that is, the solid herbicidal composition in which storage stability of flazasulfuron is obtained by a specific stabilizer.

The present inventors have studied to find a herbicidal composition which comprises, as active ingredients, flazasulfuron or a salt thereof and at least one member selected from the group consisting of glyphosate, glufosinate, bilanafos and salts thereof and has an excellent storage stability of flazasulfuron, to thereby complete the present invention.

### DISCLOSURE OF THE INVENTION

Specifically, the present invention relates to a solid herbicidal composition, comprising (1) flazasulfuron or a salt thereof, (2) at least one member selected from the group consisting of glyphosate, glufosinate, bilanafos and salts thereof, (3) a surfactant, and (4) a stabilizer.

Any salt of flazasulfuron can be used, so long as it is agriculturally acceptable. Examples include salts of alkali metals such as sodium and potassium; salts of alkaline earth metals such as magnesium and calcium; salts of amines such as monomethylamine, monoisopropylamine, dimethylamine, diisopropylamine, and triethylamine; and salts of quaternary ammonium bases such as trimethylethylammonium cation and tetramethylammonium cation.

Any salt of glyphosate can be used, so long as it is agriculturally acceptable. Examples include those similar to the salts of flazasulfuron, as well as trialkylsulfonium salts, trialkylsulfoxonium salts, and ammonium salts. Among these, sodium salts (mono-, di-, sesqui-, tri-), ammonium salts, isopropylamine salts and trimethylsulfonium salts are preferable.

Any salt of glufosinate or bilanafos can be used, so long as it is agriculturally acceptable. Examples include salts with inorganic or organic bases. Among these, sodium salts, ammonium salts, and alkyl-substituted ammonium salts are preferable.

Glufosinate and bilanafos have optical isomers, and individual isomers and racemates thereof are included within the scope of the present invention.

Examples of the surfactant include anionic surfactants such as fatty acid salts, alkylsulfosuccinates, polycarboxylates, salts of alkylsulfuric acid esters, alkyl sulfates, alkylaryl sulfates, alkyl diglycol ether sulfates, salts of alcohol sulfuric acid esters, alkyl sulfonates, alkylaryl sulfonates, aryl sulfonates, lignin sulfonates, alkyldiphenyl ether disulfonates, polystyrene sulfonates, salts of alkylphosphoric acid esters, alkylaryl phosphates, styrylaryl phosphates, salts of polyoxyethylene alkyl ether sulfuric acid esters, polyoxyethylene alkylaryl ether sulfates, salts of polyoxyethylene alkylaryl ether sulfuric acid esters, polyoxyethylene alkyl ether phosphates, salts of polyoxyethylene alkyl ether phosphoric acid esters, salts of polyoxyethylene alkylaryl phosphoric acid esters, polyoxyethylene styrylaryl ether sulfates, polyoxyethylene styrylaryl ether phosphates, salts of polyoxyethylene styrylaryl ether phosphoric acid esters, salts of naphthalenesulfonate-formalin condensates, salts of polyacrylic acid, and mixtures of two or more of them. Among these anionic surfactants, alkylsulfosuccinates are preferable and dialkylsulfosuccinates are more preferable.

Also, examples of the surfactant include nonionic surfactants such as polyoxyethylene alkyl ethers, polyoxyethylene alkylaryl ethers, polyoxyethylene alkylaryl ether formaldehyde condensates, polyoxyethylene alkylenearyl ethers, polyoxyalkylene alkyl esters, polyoxyalkylene alkyl sorbitan esters, polyoxyalkylene alkyl sorbitol esters, polyoxyalkylene alkyl glycerol esters, polyoxyalkylene block copolymers, polyoxyalkylene block copolymer alkyl glycerol esters, polyoxyalkylene alkyl sulfonamides, polyoxyalkylene rosin esters, polyoxypropylene block copolymers, polyoxyethylene oleyl ether, polyoxyalkylene alkylphenols, and mixtures of two or more of them.

The stabilizer is a substance which provides flazasulfuron with storage stability, for example, a hydrolysis inhibitor which inhibits hydrolysis of flazasulfuron. Examples include drying agents such as boric anhydride (B₂O₃), metaboric acid (HBO₂), quick lime (CaO), barium oxide (BaO), ortho boric acid (H₃BO₃, B(OH)₃), aluminium oxide (Al₂O₃), magnesium oxide (MgO), sodium aluminate (NaAlO₂), iron oxides (FeO, α-Fe₂O₃, γ-Fe₂O₃, Fe₃O₄), silica gel, anhydrous calcium chloride, calcium hydride (CaH₂), lithium alminium hydride (LiAlH₄), anhydrous sodium sulfate, anhydrous copper sulfate, anhydrous calcium sulfate, zeolite, calcium silicate, titanium oxide, silicon dioxide, activated carbon, and sodium aluminate; inorganic magnesium salts such as magnesium carbonate, magnesium hydroxide, magnesium sulfate, magnesium chloride, and magnesium nitrate; and mixtures of two or more of them. Among these stabilizers, drying agents are preferable. Furthermore, boric anhydride, metaboric acid, quick lime, barium oxide, zeolite, calcium silicate, magnesium oxide, and magnesium sulfate are preferable. Among these, boric anhydride, metaboric acid, quick lime, barium oxide, zeolite and calcium silicate are more preferable; boric anhydride and metaboric acid are still more preferable; and boric anhydride is most preferable.

In the present invention, various additives can be optionally added. Examples include carriers, acid acceptors, binders and other additives.

Examples of the carriers include diatomaceous silica, slaked lime, calcium carbonate, talc, zieklite, white carbon, bentonite, starch, sodium carbonate, sodium hydrogencarbonate, clay, zeolite, ammonium sulfate, ammonium hydrogensulfate, sodium sulfate, sodium chloride, potassium chloride, and mixtures of two or more of them. Among these carriers, ammonium sulfate is preferable.

In the present invention, when a solid herbicidal composition comprising (1) flazasulfuron or a salt thereof, (2) glyphosate (acid), (3) a surfactant and (4) a stabilizer is prepared, an acid acceptor can be added to thereby form the corresponding glyphosate salt. Examples of the acid acceptor include inorganic acid salts and organic acid salts of alkali metals (sodium, potassium, etc. ) and inorganic acid salts and organic acid salts of ammonium, such as carbonates, bicarbonates, metaborates, tetraborates, acetates, citrates, formates, oxalates, phosphates, tripolyphosphates, metaphosphates, propionates, pyrophosphates, metasilicates, orthosilicates, sulfites and thiosulfates of individual alkali metals and ammonium; hydroxides of alkali metals (sodium, potassium, etc.), such as sodium hydroxide, and potassium hydroxide; and mixtures of two or more of them. Among these acid acceptors, alkali metal carbonates are preferable, and sodium carbonate is more preferable.

Examples of the binders include various gums such as cyamoposis gum, locust bean gum, tragacanth gum, xanthan gum, and gum arabic; alginic acid derivatives such as sodium alginate, ammonium alginate, and propylene glycol alginate; organic polymer compounds such as polyvinyl alcohol, polyvinyl pyrrolidone, polyvinyl methacrylate, polyethylene oxide, polyacrylic acid, sodium polyacrylate and polyacrylamide; animal or vegetable water-soluble proteins such as albumen, albumin, casein, and gelatin; cellulose derivatives such as methylcellulose, carboxymethylcellulose, sodium salt of carboxymethylcellulose, carboxyethylcellulose, hydroxyethylcellulose, hydroxypropylcellulose, and hydroxypropylmethylcellulose; starches such as dextrin, starch, sodium salt of carboxymethylstarch, hydroxyethylstarch, and hydroxypropylstarch; ligninsulfonic acid derivatives such as sodium ligninsulfonate, and calcium ligninsulfonate; and mixtures of two or more of them.

Regarding the contents of the individual ingredients of the solid herbicidal composition according to the present invention, based on 100 parts by weight of the whole solid herbicidal composition, the content of flazasulfuron or a salt thereof is from 0.1 to 30 parts by weight, preferably from 0.1 to 10 parts by weight; the content of at least one member selected from the group consisting of glyphosate, glufosinate, bilanafos and salts thereof is from 0.1 to 80 parts by weight, preferably from 0.1 to 60 parts by weight; the content of the surfactant is from 0.1 to 50 parts by weight, preferably from 1 to 40 parts by weight; the content of the stabilizer is from 0.1 to 20 parts by weight, preferably from 1 to 15 parts by weight; when the carrier is used, the content thereof is from 0.1 to 80 parts by weight, preferably from 1 to 60 parts by weight; when the acid acceptor is used, the content thereof is from 0.1 to 30 parts by weight, preferably from 1 to 20 parts by weight; and the binder is used, the content thereof is from 0.1 to 20 parts by weight, preferably from 0.5 to 10 parts by weight.

The solid herbicidal composition according to the present invention can be prepared by mixing the ingredients in an optional order (for example, mixing glyphosate with the acid acceptor and then with other ingredients) or simultaneously mixing all ingredients together. Examples of the formulation type include wettable powders, granules, water-dispersible granules, water-soluble powders, water-soluble granules, tablets and packs (packed in water-soluble film, water-soluble paper, etc. or filled in containers made of such materials). The formulation may be prepared in accordance with commonly known methods. For example, granular solid herbicidal compositions such as granules or water-dispersible granules are prepared by mixing the ingredients, kneading the mixture with water, granulating the kneaded matter using an appropriate granulation procedure (extruding granulation, spray dry granulation, fluidized bed granulation, tumbling granulation, agitation granulation, etc.), if necessary, followed by drying and sieving.

Examples of preferred embodiments of the present invention are as follows.

(a) A solid herbicidal composition, comprising flazasulfuron or a salt thereof, glyphosate or a salt thereof, a surfactant, and a stabilizer.

(b) A solid herbicidal composition, comprising flazasulfuron or a salt thereof, glyphosate or a salt thereof, a surfactant, a stabilizer, and a carrier.

(c) A solid herbicidal composition, comprising flazasulfuron or a salt thereof, glyphosate (acid), a surfactant, a stabilizer, and an acid acceptor.

(d) A solid herbicidal composition, comprising flazasulfuron or a salt thereof, glyphosate (acid), a surfactant, a stabilizer, an acid acceptor, and a carrier.

(e) The solid herbicidal composition according to any of (a) to (d), wherein the stabilizer is a hydrolysis inhibitor.

(f) The solid herbicidal composition according to any of (a) to (d), wherein the stabilizer is a drying agent.

(g) The solid herbicidal composition according to any one of (a) to (d), wherein the stabilizer is at least one member selected from the group consisting of boric anhydride, metaboric acid, quick lime, barium oxide, zeolite, calcium silicate, magnesium oxide, and magnesium sulfate.

(h) The solid herbicidal composition according to any one of (a) to (d), wherein the stabilizer is at least one member selected from the group consisting of boric anhydride, metaboric acid, quick lime, barium oxide, zeolite, and calcium silicate.

(i) The solid herbicidal composition according to any one of (a) to (d), wherein the stabilizer is at least one member selected from the group consisting of boric anhydride and metaboric acid.

(j) The solid herbicidal composition according to any one of (a) to (d), wherein the stabilizer is boric anhydride.

(k) The solid herbicidal composition according to any one of (a) to (d), which is in the granular form.

(l) The solid herbicidal composition according to any one of (a) to (d), which is in the form of a wettable powder.

(m) The solid herbicidal composition according to any one of (a) to (d), which is in the form of water-dispersible granules.

(n) The solid herbicidal composition according to any one of (a) to (d), which is in the form of a water-soluble powder.

(o) The solid herbicidal composition according to any one of (a) to (d), which is in the form of water-soluble granules.

Moreover, it is possible to inhibit growth of an undesirable plant by using the solid herbicidal composition according to the present invention. The term “undesirable plant” as used herein means, for example, a plant providing field crops with undesirable effects. The growth of the plant can be selectively inhibited by applying the solid herbicidal composition according to the present invention,

### BEST MODE FOR CARRYING OUT THE INVENTION

The present invention are described in detail by reference to the following examples. However, the present invention is not limited thereto. First, Formulation Examples are described below.

### FORMULATION EXAMPLE 1

| | |
|---|---|
| Flazasulfuron (purity: 97.5%) | 1.54 g |
| Glyphosate (purity: 87.9%) | 28.94 g |
| Sodium dioctylsulfosuccinate | 5.00 g |
| (trade name: GEROPON SDS ™, | |
| manufactured by Rhodia Nicca, Ltd.) | |
| Boric anhydride | 5.00 g |
| Ammonium sulfate | 46.94 g |
| Sodium carbonate | 9.58 g |

The above ingredients were mixed together and then kneaded with 10 g of water. The kneaded mixture was granulated with a busket type extruding granulator (screen size: 0.8 mmφ), dried on a fluidized bed and then sieved (14-60 mesh) to give 100 g of water-dispersible granules.

### FORMULATION EXAMPLE 2

| | |
|---|---|
| Flazasulfuron (purity: 97.5%) | 1.54 g |
| Glyphosate (purity: 87.9%) | 28.94 g |
| GEROPON SDS | 5.00 g |
| Boric anhydride | 5.00 g |
| Ammonium sulfate | 45.94 g |
| Sodium carbonate | 9.58 g |
| 50% Aqueous solution of | 2.00 g |
| calcium ligninsulfonate | |
| (trade name: SANEKISU C ™, manufactured by | |
| Nippon Paper Industries Co., Ltd.) | |

The above ingredients were mixed together and then kneaded, granulated, dried and sieved as in the above Formulation Example 1 to give 100 g of water-dispersible granules.

### FORMULATION EXAMPLE 3

| | |
|---|---|
| Flazasulfuron (purity: 97.5%) | 1.54 g |
| Glyphosate (purity: 87.9%) | 33.74 g |
| GEROPON SDS | 5.00 g |
| Boric anhydride | 5.00 g |
| Ammonium sulfate | 39.56 g |
| Sodium carbonate | 11.16 g |
| SANEKISU C | 2.00 g |

The above ingredients were mixed together and then kneaded, granulated, dried and sieved as in the above Formulation Example 1 to give 100 g of water-dispersible granules.

### FORMULATION EXAMPLE 4

| | |
|---|---|
| Flazasulfuron (purity: 97.5%) | 1.54 g |
| Glyphosate (purity: 87.9%) | 33.74 g |
| GEROPON SDS | 10.00 g |
| Boric anhydride | 5.00 g |
| Ammonium sulfate | 34.56 g |
| Sodium carbonate | 11.16 g |
| SANEKISU C | 2.00 g |

The above ingredients were mixed together and then kneaded, granulated, dried and sieved as in the above Formulation Example 1 to give 100 g of water-dispersible granules.

### FORMULATION EXAMPLE 5

| | |
|---|---|
| Flazasulfuron (purity: 97.5%) | 1.54 g |
| Glyphosate (purity: 87.9%) | 33.74 g |
| GEROPON SDS | 5.00 g |
| Boric anhydride | 5.00 g |
| Ammonium sulfate | 40.56 g |
| Sodium carbonate | 11.16 g |

The above ingredients were mixed together and then kneaded, granulated, dried and sieved as in the above Formulation Example 1 to give 100 g of water-dispersible granules.

### FORMULATION EXAMPLE 6

| | |
|---|---|
| Flazasulfuron (purity: 95.1%) | 1.54 g |
| Glyphosate (purity: 87.9%) | 34.40 g |
| GEROPON SDS | 5.00 g |
| Magnesium oxide | 5.00 g |
| Ammonium sulfate | 44.84 g |
| Sodium carbonate | 11.38 g |

The above ingredients were mixed together and then kneaded, granulated, dried and sieved as in the above Formulation Example 1 to give 100 g of water-dispersible granules.

### FORMULATION EXAMPLE 7

| | |
|---|---|
| Flazasulfuron (purity: 95.1%) | 1.54 g |
| Glyphosate (purity: 87.9%) | 34.40 g |
| GEROPON SDS | 5.00 g |
| Magnesium sulfate | 5.00 g |
| Ammonium sulfate | 44.84 g |
| Sodium carbonate | 11.38 g |

The above ingredients were mixed together and then kneaded, granulated, dried and sieved as in the above Formulation Example 1 to give 100 g of water-dispersible granules.

### FORMULATION EXAMPLE 8

| | |
|---|---|
| Flazasulfuron (purity: 95.1%) | 1.54 g |
| Glyphosate (purity: 87.9%) | 34.40 g |
| GEROPON SDS | 5.00 g |
| Calcium silicate | 5.00 g |
| Ammonium sulfate | 44.84 g |
| Sodium carbonate | 11.38 g |

The above ingredients were mixed together and then kneaded, granulated, dried and sieved as in the above Formulation Example 1 to give 100 g of water-dispersible granules.

### FORMULATION EXAMPLE 9

| | |
|---|---|
| Flazasulfuron (purity: 95.1%) | 0.32 g |
| Glyphosate (purity: 87.9%) | 3.00 g |
| GEROPON SDS | 15.00 g |
| Boric anhydride | 10.00 g |
| Ammonium sulfate | 65.94 g |
| Sodium carbonate | 1.10 g |
| SANEKISU C | 6.00 g |

The above ingredients, except SANEKISU C, were mixed together and then kneaded with SANEKISU C and 6 g of water. The kneaded mixture was granulated with a busket type extruding granulator (screen size: 0.8 mmφ), dried on a fluidized bed and then sieved (14-60 mesh) to give 100 g of water-dispersible granules.

### FORMULATION EXAMPLE 10

| | |
|---|---|
| Flazasulfuron (purity: 95.1%) | 21.00 g |
| Glyphosate (purity: 87.9%) | 56.80 g |
| GEROPON SDS | 0.50 g |
| Boric anhydride | 2.00 g |
| Ammonium sulfate | 5.50 g |
| Sodium carbonate | 18.00 g |
| SANEKISU C | 2.00 g |

The above ingredients were mixed together and then kneaded, granulated, dried and sieved as in the above Formulation Example 9, except for using 10 g of water, to give 100 g of water-dispersible granules.

### FORMULATION EXAMPLE 11

| | |
|---|---|
| Flazasulfuron (purity: 95.1%) | 1.54 g |
| Glyphosate (purity: 87.9%) | 34.40 g |
| GEROPON SDS | 5.00 g |
| Boric anhydride | 5.00 g |
| Ammonium sulfate | 40.04 g |
| Sodium carbonate | 11.18 g |
| SANEKISU C | 10.00 g |

The above ingredients were mixed together and then kneaded, granulated, dried and sieved as in the above Formulation Example 9, except for using 3 g of water, to give 100 g of water-dispersible granules.

### FORMULATION EXAMPLE 12

| | |
|---|---|
| Flazasulfuron (purity: 97.5%) | 1.54 g |
| Glufosinate (purity: 95.2%) | 34.20 g |
| GEROPON SDS | 5.00 g |
| Ammonium sulfate | 41.96 g |
| Boric anhydride | 5.00 g |
| Sodium carbonate | 10.30 g |

The above ingredients were mixed together and then kneaded, granulated, dried and sieved as in the above Formulation Example 1, except for using 12 g of water, to give 100 g of water-dispersible granules.

### COMPARATIVE FORMULATION EXAMPLE 1

| | |
|---|---|
| Flazasulfuron (purity: 97.5%) | 1.54 g |
| Glyphosate (purity: 87.9%) | 33.74 g |
| GEROPON SDS | 5.00 g |
| Ammonium sulfate | 45.56 g |
| Sodium carbonate | 11.16 g |

The above ingredients were mixed together and then kneaded, granulated, dried and sieved as in the above Formulation Example 1 to give 100 g of water-dispersible granules.

### COMPARATIVE FORMULATION EXAMPLE 2

| | |
|---|---|
| Flazasulfuron (purity: 95.1%) | 1.54 g |
| Glyphosate (purity: 87.9%) | 34.40 g |
| GEROPON SDS | 5.00 g |
| Ammonium sulfate | 49.84 g |
| Sodium carbonate | 11.38 g |

The above ingredients were mixed together and then kneaded, granulated, dried and sieved as in the above Formulation Example 1 to give 100 g of water-dispersible granules.

Next, Test Example is described below.

### TEST EXAMPLE 1

Storage Stability Test of Flazasulfuron:

About 30 g of the water-dispersible granules obtained in Formulation Examples 1 to 8 and Comparative Formulation Examples 1 and 2 were put into screw-capped glass sample bottles and stored under various acceleration test conditions. Then, the samples were analyzed by liquid chromatography to determine the decomposition rates of flazasulfuron. The results are shown in Table 1.

TABLE 1

| Formulation | Decomposition rate (%) of flazasulfuron | | |
|---|---|---|---|
| Example No. | 60° C., 1 week | 54° C., 2 weeks | 40° C., 1 month |
| 1 | 5 | 6 | 3 |
| 2 | 7 | 10 | — |
| 3 | 7 | 7 | 2 |
| 4 | 6 | 6 | 2 |
| 5 | 6 | 5 | — |
| 6 | — | 11 | — |
| 7 | — | 12 | — |
| 8 | — | 14 | — |
| Comparative | 45 | 27 | 11 |
| Formulation | | | |
| Example 1 | | | |
| Comparative | — | 20 | — |
| Formulation | | | |
| Example 2 | | | |

### INDUSTRIAL APPLICABILITY

As described above, the present invention provides stable solid herbicidal compositions.

1. A solid herbicidal composition, comprising (1) 1-(4,6-dimethoxypyrimidin-2-yl)-3-(3-trifluoromethyl-2-pyridylsulfonyl)urea or a salt thereof, (2) at least one member selected from the group consisting of N-(phosphonomethyl)glycine, 4-[hydroxy(methyl)phosphinoyl]homoalanine, 4-[hydroxy(methyl)phosphinoyl]homoalanylalanylalanine and salts thereof, (3) a surfactant, and (4) a stabilizer.

2. The solid herbicidal composition according to claim 1, which further comprises a carrier.

3. The solid herbicidal composition according to claim 1 or 2, wherein the stabilizer is a hydrolysis inhibitor.

4. The solid herbicidal composition according to claim 1 or 2, wherein the stabilizer is a drying agent.

5. The solid herbicidal composition according to claim 1 or 2, wherein the stabilizer is at least one member selected from boric anhydride, metaboric acid, quick lime, barium oxide, zeolite, calcium silicate, magnesium oxide, and magnesium sulfate.

6. The solid herbicidal composition according to claim 1 or 2, wherein the stabilizer is at least one member selected from boric anhydride, metaboric acid, quick lime, barium oxide, zeolite, and calcium silicate.

7. The solid herbicidal composition according to claim 1 or 2, wherein the stabilizer is at least one member selected from boric anhydride and metaboric acid.

8. The solid herbicidal composition according to claim 1, which comprises (1) 1-(4,6-dimethoxypyrimidin-2-yl)-3-(3-trifluoromethyl-2pyridylsulfonyl)urea or a salt thereof in an amount of 0.1 to 30 parts by weight, (2) the at least one member selected from the group consisting of N-(phosphonomethyl)glycine, 4-[hydroxy(methyl)phosphinoyl]homoalanine, 4-[hydroxy(methyl)phosphinoyl]homoalanylalanylalanine and salts thereof in an amount of 0.1 to 80 parts, (3) the surfactant in an amount of 0.1 to 50 parts by weight, and (4) the stabilizer in an amount of 0.1 to 20 parts by weight.

9. The solid herbicidal composition according to claim 2, which comprises the carrier in an amount of 0.1 to 80 parts by weight.

10. A granular solid herbicidal composition, which is obtained by kneading (1) 1-(4,6-dimethoxypyrimidin-2-yl)-3-(3-trifluoromethyl-2-pyridylsulfonyl)urea or a salt thereof, (2) at least one member selected from the group consisting of N-(phosphonomethyl)glycine, 4-[hydroxy(methyl)phosphinoyl]homoalanine, 4-[hydroxy(methyl)phosphinoyl]homoalanylalanylalanine and salts thereof, (3) a surfactant, and (4) a stabilizer with water, followed by granulating.

11. The granular solid herbicidal composition according to claim 10, which is obtained by kneading (1) 1-(4,6-dimethoxypyrimidin-2-yl)-3-(3-trifluoromethyl-2-pyridylsulfonyl)urea or a salt thereof, (2) at least one member selected from the group consisting of N-(phosphonomethyl)glycine, -4-[hydroxy (methyl)phosphinoyl]homoalanine, 4-[hydroxy(methyl)phosphinoyl]homoalanylalanylalanine and salts thereof, (3) a surfactant, (4) a stabilizer, and (5) a carrier, with water, followed by granulating.

12. A method for inhibiting growth of an undesirable plant, which comprises using the solid herbicidal composition of claim 1 or 2.
